(19) United States
(12) Patent Application Publication
(10) Pub. No.: US 2021/0402575 A1
(43) Pub. Date: Dec. 30, 2021

(54) QUICK-ADJUST PIPE WRENCH

(71) Applicant: JBH Innovations.Inc., Wexford, PA (US)

(72) Inventor: Jeffrey B. Hile, Wexford, PA (US)

(73) Assignee: JBH Innovations, Inc., Wexford, PA (US)

(21) Appl. No.: 16/933,252

(22) Filed: Jul. 20, 2020

Related U.S. Application Data
(60) Provisional application No. 63/045,068, filed on Jun. 27, 2020.

(51) Int. Cl. B25B 13/50

(52) U.S. Cl. CPC B25B 13/5058

(57) ABSTRACT

A quick-adjust pipe wrench wherein a sliding casing carrying the lower jaw is slidable on a wrench shank toward and away from an upper jaw mounted on the head end of the shank, and a brake surface on the slidable casing is biased to engage a gripping surface on the shank of the wrench. The brake surface is carried by a brake lever having a depression contact area directly below the lower jaw on the casing. The gripping surface and brake surface provide a sliding rack catch which permits the casing with the lower jaw to slide toward the upper jaw but ensures that the casing with its lower jaw member cannot be moved away from the upper jaw member without disengaging the meshed teeth of the shank gripping surface and the brake surface.

### CROSS REFERENCE

This application claims the benefit of U.S. Provisional Application No. 63/045,068, filed Jun. 27, 2020 for QUICK ADJUST PIPE WRENCH, the contents of which are incorporated herein in its entirety.

### BACKGROUND OF THE INVENTION

The present invention pertains to the field of adjustable wrenches, and more particularly to a quick-adjust pipe wrench.

Various constructions have been proposed for pipe wrenches which are more easily and quickly adjustable than the original pipe wrenches which are cumbersome and slow to operate, mainly because they are operated by a screw adjustment wherein the parts are subject to becoming clogged, distorted or otherwise rendered difficult or impossible to operate.

A considerable number of quick adjust pipe wrenches have been developed over the years, however, such new quick adjust designs still incorporate flaws leaving room for new designs which provide pipe wrenches which are easier and even quicker to adjust and provide more secure gripping of the object engaged by the pipe wrench and ensure that the wrench will not lose its initial grip of the object engaged. It is thus an object of the present invention to provide such an improved quick adjust pipe wrench.

### SUMMARY OF THE INVENTION

The quick adjust pipe wrench of the present invention provides an elongated shank having a handle end and a head end mounting in inverted L-shaped upper jaw with a transversely protruding upper jaw member. A sliding casing is slidably mounted on the shank and defines a sliding lower jaw facing the upper jaw member. The slidable casing is slidable on the shank alternatively toward or away from the upper jaw member.

The jaw side of the shank (the side of the shank from which the jaws protrude) is provided with an elongated gripping surface. A brake lever is pivotally mounted on the sliding casing and is spring biased for engagement of a brake surface on the brake lever with the gripping surface on the side of the shank for locking the casing from sliding away from the upper jaw. The brake lever is provided with a depression contact area that is exposed under the lower jaw for thumb or finger engagement by an operator to disengage the brake surface from the gripping surface.

The gripping surface and the brake surface provide in combination a sliding rack catch consisting of intermeshing racks of teeth. The gripping surface teeth have transverse teeth ridges pointing upward toward the upper jaw and the brake surface has transverse teeth ridges pointing downward away from the upper jaw whereby the sliding casing will slide upwardly toward the upper jaw but is braked against downwardly sliding movement away from the upper jaw when the brake surface teeth are meshed with the gripping surface teeth.

An additional feature is provided wherein the inverted L-shaped upper jaw is pivotally mounted to the head end of the shank and is spring biased against a stop and rotatable away from the stop against this spring biased to rotate the transversely protruding upward jaw member upwardly away from the lower jaw. Thus upon initial contact of the upper and lower jaws with an object to be secured in the jaws, the upper jaw is permitted to slightly open the grip on the object to provide more effective grip positioning on the object, and when the shank of the wrench is initially rotated to rotate the engaged object, the upper jaw is enabled to more firmly engages the object with a sure grip.

### BRIEF DESCRIPTION OF THE DRAWINGS

Other objects and advantages appear hereinafter in the following description and claims. The accompanying drawings show, for the purpose of exemplification, without limiting the scope of the invention and the appended claims, certain practical embodiments of the invention wherein:

FIG. 1 is a view in side elevation of the pipe wrench of the present invention;

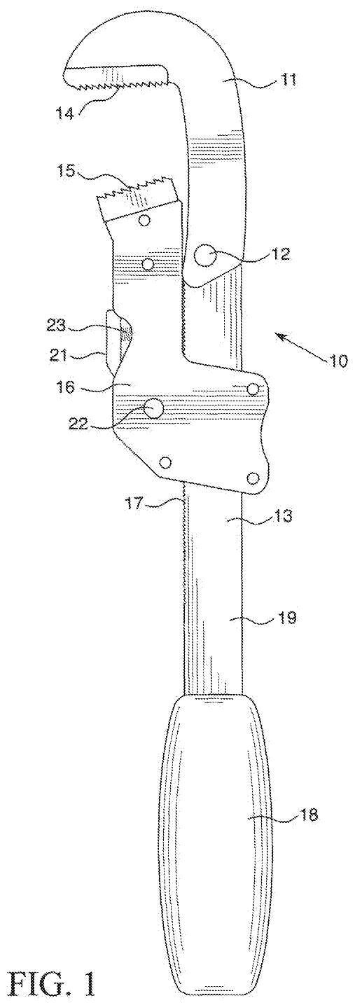

FIG. 2 is a view in side elevation of the pipe wrench shown in FIG. 1 with portions thereof exposed for illustrating the operation of internal mechanisms;

FIG. 3A is an enlarged view of the mid-section of the pipe wrench shown in FIGS. 2; and

FIG. 3B is an enlarged view of the operational mechanism shown in FIG. 2 illustrating the brake lever mechanism under depression in order to permit the lower jaw to freely slide downwardly away from the upper jaw.

### DETAILED DESCRIPTION OF THE DRAWINGS

Referring to the drawings, the quick-adjust pipe wrench 10 of the present invention includes an elongated shank 13 having a handle 18 at end 19 and an inverted L-shaped upper jaw 11 at its head with a transversely protruding upper jaw member 14. A sliding casing 16 is slidably mounted on shank 13 and defines a sliding lower jaw 15 facing upper jaw member 14. Casing 16 is slidable on shank 13 alternatively toward or away from upper jaw member 14.

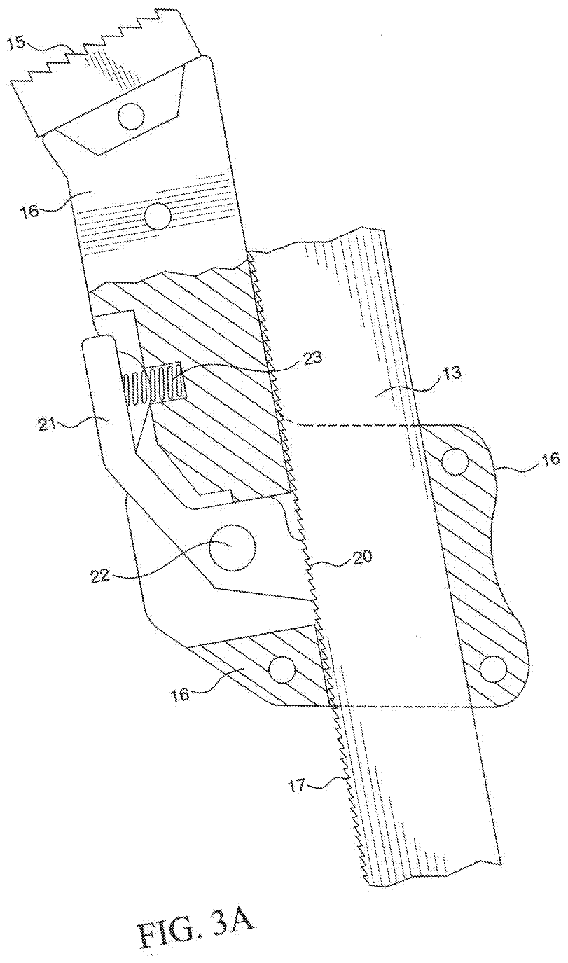

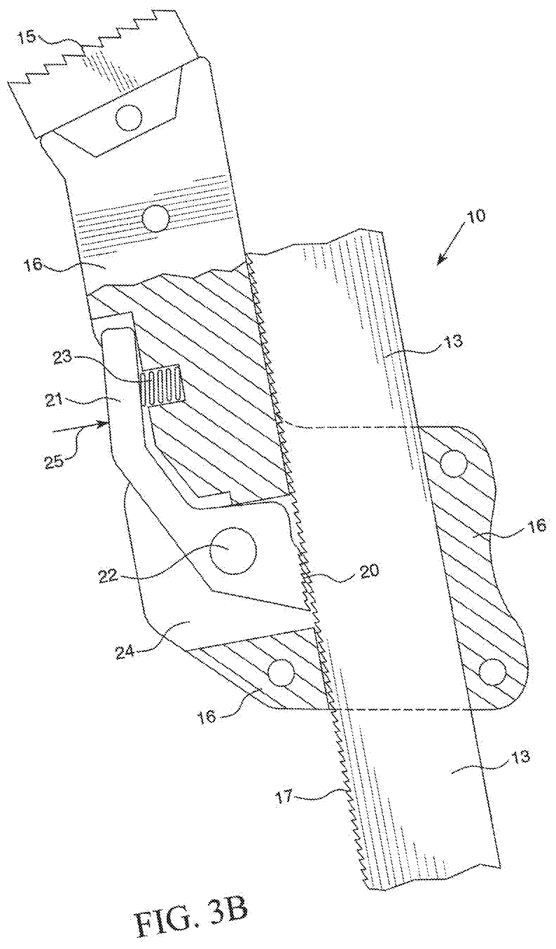

Shank 13 on its jaw side is provided with elongated gripping surface 17. Brake lever 21 is pivotally mounted at 22 on sliding casing 16 and is spring biased by spring 23 for engagement of brake surface 20 on brake lever 21 with gripping surface 17 for locking casing 16 from sliding away from upper jaw member 14. Brake lever 21 is provided with a depression contact area for thumb or finger engagement by an operator to depress brake lever 21 against the bias of spring 23 as indicated by arrow 25 in FIG. 3B. This contact area is exposed under lower jaw 15 as shown for convenient and easy thumb engagement by an operator.

The gripping surface 17 and the brake surface 20 provide in combination a sliding rack catch consisting of intermeshing racks of teeth. The gripping surface teeth of gripping surface 17 have transverse teeth ridges as shown best in FIGS. 3A and 3B that point upwardly toward upper jaw member 14, and the transverse teeth on brake surface 20 have ridges pointing downwardly away from upper jaw member 14 whereby sliding casing 16 will slide upwardly toward upper jaw member 14 as the teeth of brake surface 20 will readily ride over the teeth of gripping surface 17 even though the teeth of brake surface 20 are meshed with the teeth of gripping surface 17 as illustrated in FIG. 3A. Obviously in this situation casing 16 is positively and securely retained from moving downwardly away from upper jaw member 14. The tooth rack of brake surface 20 absolutely ensures against possible downward movement of casing 16 away from upper jaw member 14.

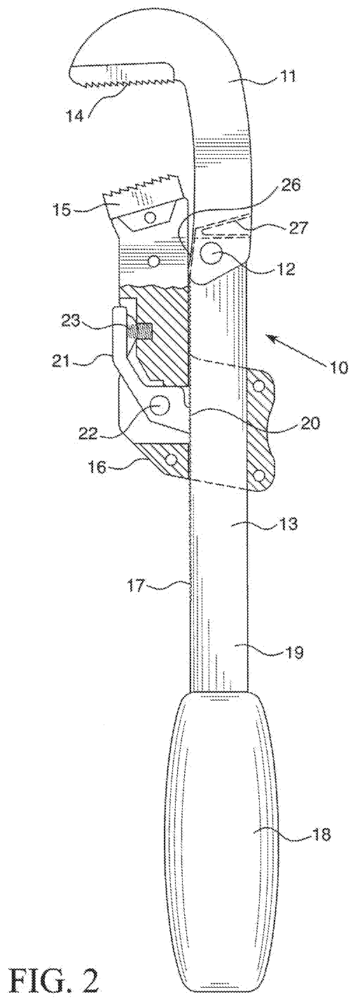

The pipe wrench 10 is also provided with an inverted L-shaped upper jaw 11 that is pivotally mounted at pivot 12 to the head end of shank 13 and, as shown in phantom in FIG. 2, is spring biased against stop 26 by U-shaped clip spring 27 and is rotatable away from stop 26 against the bias of spring 27 to rotate transversely protruding upper jaw member 14 upwardly away from lower jaw 15. Upon initial engagement of jaws 14 and 15 with a pipe or other object (not shown) to be engaged by wrench 10, this permits upper jaw member 14 to slightly rotate away from lower jaw 15 upon initial engagement of the jaws with an object. This presets upper jaw 14 in a desired position to more securely fit and grip the object between the jaws 14 and 15 once the shank 13 is initially rotated in the clockwise direction as viewed in the figures to rotate the engaged object with the wrench 10.

I claim:

1. A quick-adjust pipe wrench comprising:
an elongated shank having a handle end a head end mounting an inverted L-shaped upper jaw with a transversely protruding upper jaw member;
a sliding casing slidably mounted on said shank and defining a sliding lower jaw facing said upper jaw member and slidable on said shank alternatively toward or away from said upper jaw member;
said shank having a jaw facing side with an elongated gripping surface;
a brake lever pivotally mounted on said sliding casing and spring biased for engagement of a brake surface on said brake lever with said gripping surface for locking said casing from sliding away from said upper jaw, said brake lever having a depression contact area exposed under said lower jaw for thumb or finger engagement by an operator to disengage said brake surface from said gripping surface;
said gripping surface and said brake surface providing a sliding rack catch consisting of intermeshing racks of teeth, said gripping surface teeth having transverse teeth ridges pointing upward toward said upper jaw and said brake surface having transverse teeth ridges pointing downward away from said upper jaw whereby said sliding casing will slide upwardly toward said upper jaw but is braked against downwardly sliding movement away from said upper jaw when said brake surface teeth are meshed with said gripping surface teeth.

2. The quick-adjust pipe wrench of claim 1, wherein said inverted L-shaped upper jaw is pivotally mounted to said head end of said shank and is spring biased against a stop and rotatable away from said stop against said spring bias to rotate said transversely protruding upper jaw member upwardly away from said lower jaw.
